(19) United States
(12) Patent Application Publication
(10) Pub. No.: US 2015/0135967 A1
(43) Pub. Date: May 21, 2015

(54) Single-Serve Cartridge with Pressure Relief Valve

(71) Applicant: Plitek, L.L.C., Des Plaines, IL (US)

(72) Inventors: Karl K. Hoffman, Arlington Heights, IL (US); John Ozcomert, Bartlett, IL (US); Robert C. Larsen, Bartlett, IL (US)

(73) Assignee: Plitek, L.L.C., Des Plaines, IL (US)

(21) Appl. No.: 14/086,753

(22) Filed: Nov. 21, 2013

(51) Int. Cl. A47J 31/40; A47J 31/44

(52) U.S. Cl. CPC A47J 31/407; A47J 31/4407
USPC 99/295; 220/203.19

(57) ABSTRACT

An improved single-serve cartridge with a one-way gas pressure relief valve for beverage brewing, preferably in an automatic single-serve beverage brewer device such as the Keurig® Single Cup Brewing System, and cartridge components are described. In embodiments, the improved cartridge contains ground coffee or other particulate beverage medium. A one-way gas pressure relief valve permits gas produced by the ground coffee to escape from the cartridge before use of the cartridge in a brewer, thereby avoiding certain disadvantages associated with excessive pressure within the cartridge. The one-way gas pressure relief valve is also essentially liquid-tight to liquid injected into the cartridge by the brewer avoiding problems associated with liquid leakage and allowing the cartridge to function in the brewer in the same manner as an unmodified cartridge. The improved cartridge enables ground coffee, in particular, to be packaged immediately following roasting and grinding when at its optimal freshness to provide for improved beverage flavor and quality while maintaining package quality and integrity.

### FIELD

The field relates to cartridges for beverage brewing and, more particularly, to cartridges and cartridge components which provide for improved beverage flavor and quality.

### BACKGROUND

Single-serve beverage brewers are well-known devices used to brew a cup of coffee, tea, hot chocolate, or other beverage. One such example of a single-serve beverage brewer is the Keurig® Single Cup Brewing System available from Green Mountain Coffee Roasters, Inc. of Waterbury, Vt. The Keurig Single Cup Brewing System includes an automatic brewer which injects hot water under pressure into a sealed cartridge containing ground coffee or other particulate beverage medium. The hot water mixes with the ground coffee in the cartridge to brew the coffee. The freshly-brewed coffee is subsequently delivered by the brewer to the user's cup. Importantly, hot water used to brew the coffee and the liquid coffee must not leak from the cartridge during this process because any liquid leakage would interfere with the brewing process and operation of the brewer and could create an unacceptable mess requiring clean up by the user. A further problem associated with water leakage is that any water which escapes from the cartridge can flow down and into the user's cup diluting the coffee or other beverage in the cup.

The cartridge used with the Keurig Single Cup Brewing System is known as a K-Cup®. FIGS. 1-8 illustrate an exemplary K-Cup-type cartridge 1. A K-Cup is a cartridge 1, or container, with an internal filter element 3 and roasted ground coffee 5 or other particulate beverage medium deposited in the filter element 3. Cartridge 1 is sealed with a lid 7 to enclose the ground coffee 5 or other particulate beverage medium therein. The K-Cup-type cartridge 1 provides a hermetically-sealed package which protects the freshness and quality of the ground coffee 5 or other particulate beverage medium therein.

A problem confronting coffee roasters which package ground coffee 5 in K-Cup-type cartridges 1 is that the roaster must make a compromise between the integrity and performance of the cartridge 1 and the freshness and quality of the coffee packaged in the cartridge 1. This integrity and performance problem arises because coffee produces carbon dioxide gas after it is roasted, ground and packaged. The positive gas pressure can build within the cartridge 1, causing the cartridge 1 to swell and become distorted.

The pressure build up within the K-Cup-type cartridge 1 and the resultant expansion and distortion can adversely affect the cartridge 1 by potentially preventing the cartridge 1 from being properly seated within the brewer. Distortion and swelling of cartridge 1, or multiple cartridges 1, can also damage or rupture the carton or secondary package (not shown) in which a plurality of cartridges 1 are packaged. This carton or secondary package can, for example, be made of cardboard which closely encloses the cartridges 1. The carton or secondary package can be broken open by expansion of plural cartridges 1. The carton or secondary package may not be salable at retail if it is broken. Moreover, a case containing many cartons or secondary packages can similarly be broken open by expanding cartridges and delivery may be refused by the wholesaler. Cartridge 1 distortion is also undesirable from a performance standpoint because a customer could perceive a swollen K-Cup-type cartridge 1 as being defective and potentially unsafe because of microorganism contamination.

In extreme circumstances, the swelling and distortion can cause the cartridge 1 to rupture and fail compromising package integrity. A K-Cup-type cartridge 1 could fail if the K-Cup lid 7 became detached from the cartridge 1. Any failure of the K-Cup-type cartridge 1 would result in damage or loss of the ground coffee 5 within the cartridge 1.

A compromise can be made to minimize risk of K-Cup-type cartridge 1 distortion and failure by “degassing” the ground coffee before packaging in the cartridge 1. Degassing represents a compromise because degassing reduces the risk of package distortion and failure, but can also degrade the freshness and quality of the degassed ground coffee 5. Degassing involves spreading the ground coffee 5 on a surface for between 24 to 48 hours after roasting and grinding so that carbon dioxide gas can be released. Ground coffee is particularly active in carbon dioxide production within this period of degassing. Because the ground coffee will produce relatively less carbon dioxide gas after degassing, the roasted and ground coffee can be packaged with a reduced risk of cartridge 1 distortion or failure.

The loss of ground coffee 5 freshness and quality which occurs during degassing may degrade the flavor of the ground coffee. Ground coffee 5 packaged in a K-Cup-type cartridge 1 or other cartridge type following degassing is not optimally fresh and flavorful. This is a particular disadvantage for the Keurig Single Cup Brewing System and ground coffee 5 packaged in K-Cup-type cartridges 1 because users of these premium coffee-brewing products are discerning and expect a superior coffee experience with optimal coffee freshness and flavor.

Thus, the roaster must attempt to strike the appropriate balance between packaging performance, appearance and integrity and the quality of the coffee or other beverage brewed by means of the K-Cup-type cartridge 1 or other cartridge type. Striking the appropriate balance can result in a less-than-optimal coffee experience for the consumer.

It would be an improvement in the art to provide a single-serve cartridge and cartridge components compatible for use with the Keurig Single Cup Brewing System and similar brewing systems, which would permit proper operation of the brewer in which the cartridge is loaded, which would avoid liquid leakage during brewing, which would optimize the freshness and flavor of the coffee or other particulate beverage medium packaged in the cartridge, which would avoid gas build up within the cartridge and cartridge distortion and which would provide an optimal experience for the consumer.

### SUMMARY

Certain embodiments of the present invention are concerned with providing a single-serve beverage cartridge into which liquid, typically hot water, is injected under pressure by a brewer, such as a Keurig brand Single Cup Brewing System. One highly preferred type of cartridge is a K-cup cartridge. The cartridges are ideal for the brewing of coffee from particulate beverage medium within the cartridge, although the cartridges may be used with beverages other than coffee. Cartridge embodiments of the types described herein restrict air entry into the cartridge, allow gas generated by the coffee to be vented from the cartridge before brewing and yet limit liquid flow out of the cartridge during the brewing process. The result is that the coffee roaster can package roasted, ground coffee in the cartridge while optimally flavorful without risk of compromising package quality or integrity.

In embodiments, a single-serve beverage cartridge comprises the combination of a single-serve cartridge and a one-way pressure relief valve. In an embodiment, the cartridge comprises a cup, a lid and a granular beverage medium within the cup. The cup has a shape and is preferably of a gas-and-liquid impermeable material. The cup preferably includes a rim defining an opening. A lid which is preferably of a gas-and-liquid impermeable material is sealed to the rim entirely around the opening and covering the opening. The cartridge further includes a vent, a puncture zone and a separate valve placement zone. In embodiments, a brewer needle can inject the liquid into the cartridge through the puncture zone. The granular beverage generates gas creating pressure within the cartridge before the liquid injection.

In embodiments, the preferred one-way gas pressure relief valve vents gas from the cartridge yet is liquid-tight to injected liquid. A preferred valve comprises a base layer and a flexible seal. The base layer is preferably affixed over the vent in the cartridge entirely within the valve placement zone. It is most highly preferred that the lid includes the vent, the valve placement zone and the puncture zone. Preferably, the valve is attached to the lid in gas flow communication with the vent and in the valve placement zone. Such placement can avoid interference with insertion of a brewer entrance needle into the cartridge. In embodiments, the vent has a cross-sectional area of less than about 0.00019 in². Such a relatively small vent size contributes to restriction of liquid flow out of the cartridge during the brewing process.

In embodiments, the base layer includes a first side, a second side, at least one hole entirely through the base layer and adhesive on the second side affixing the base layer to the cartridge and most preferably to the lid. In the embodiment, the at least one hole has a total cross-sectional area of less than about 0.000314 in². In other embodiments, the base layer of the valve can include plural holes. In such embodiments, the plural holes have a total cross-sectional area of less than about 0.000314 in².

A liquid flow-restricting baffle is formed by an inner edge of the adhesive surrounding the at least one hole. The baffle is positioned over the vent and in gas-flow communication with the at least one hole. It is preferred that the inner edge of the adhesive defining the baffle is spaced entirely from the at least one hole in the base layer. The baffle contributes to limit and prevent leakage of liquid from the cartridge by reducing force of the liquid injected into the cartridge by the brewer.

In embodiments, the flexible seal includes a first region joined to the base layer first side spaced at least partially from the at least one hole and a second region unjoined to the base layer first side covering the at least one hole. The regions define, together with the base layer first side, a gas flow path from the at least one hole to a periphery of the flexible seal. The flexible seal flexes responsive to the gas pressure to at least partially open the gas flow path and permit gas outflow from the cartridge. Such gas flow path also preferably includes a path from the baffle and through the at least one hole. The valve relieves the gas pressure before the liquid injection thereby maintaining the cup shape and the gas seal while permitting the beverage medium to be packaged in the cartridge without substantial degassing and limits flow of the injected liquid out of the cartridge.

It is preferred that the flexible seal first region is joined to the base layer first side by an adhesive. In embodiments, the flexible seal flexes to allow gas to flow along the gas flow path when cartridge internal gas pressure exceeds ambient air pressure by about 0.2 psig.

In certain embodiments, a wetting agent may be provided between the base layer and flexible seal. A wetting agent facilitates air-tight closure of the valve and cartridge.

In other embodiments, first and second layers which are releasably held together are utilized to facilitate air-tight closure of the valve and cartridge. The first and second layers can comprise a first layer atop the base layer first side around the base layer hole, a flexible cover layer over the first layer and the base layer hole and a second layer supported by the flexible cover layer facing the first layer and covering the base layer hole. In such embodiments, the first and second layers are releasably held together to form a seal blocking passage of gas into the cartridge. Flexing of the flexible seal separates the first and second layers sufficiently to allow gas to flow along the gas flow path.

In embodiments, the valve is sized to have a footprint area of less than about 0.25 in².

In embodiments in which the lid is circular in shape, the lid defines a circle with a center and the puncture zone comprises a circle concentric with the center. In such embodiments, the valve placement zone is concentric with both the center and the puncture zone. The lid may have a radius of less than about 1 inch and the puncture zone may have a radius of about 0.5 inch.

In embodiments, the invention may be implemented as a lid component for closure of a single-serve beverage cartridge. The lid may be supplied as a component separate from other components of the cartridge and may be attached to the cartridge at any suitable point of the manufacturing process.

Other features and embodiments are described in the drawings and detailed description which follows.

### BRIEF DESCRIPTION OF THE DRAWINGS

Exemplary single-serve cartridges and components with a one-way gas pressure relief valve may be understood by reference to the following description taken in conjunction with the accompanying drawings, in which like reference numerals identify like elements throughout the different views. For convenience and brevity, like reference numbers are used for like parts amongst the embodiments. The drawings are not necessarily to scale, emphasis instead being placed upon illustrating the principles of the invention. In the accompanying drawings:

FIG. 1 is a perspective view of an exemplary K-Cup-type cartridge;

FIG. 2 is a top plan view of the cartridge of FIG. 1;

FIG. 3 is a side elevation view of the cartridge of FIG. 1;

FIG. 4 is a section view taken along section 4-4 of FIG. 3;

FIG. 5 is a perspective view of the exemplary cartridge of FIG. 1, but illustrating the distorting effect of a pressure increase within the cartridge;

FIG. 6 is a top plan view of the cartridge of FIG. 5;

FIG. 7 is a side elevation view of the cartridge of FIG. 5;

FIG. 8 is a section view taken along section 8-8 of FIG. 7;

FIG. 9 is a perspective view of the exemplary cartridge of FIGS. 1-8, but after failure of the cartridge;

FIG. 9A is an enlarged perspective view taken along section 9A of FIG. 9;

FIG. 10 is a perspective view of an exemplary K-Cup-type cartridge including a pressure relief valve;

FIG. 11 is a top plan view of the cartridge of FIG. 10;

FIG. 12 is a side elevation view of the cartridge of FIG. 10;

FIG. 13 is a section view taken along section 13-13 of FIG. 12;

FIG. 14 is an exploded view of the exemplary pressure relief valve of FIGS. 10-13;

FIG. 14A is an exploded view of a further exemplary pressure relief valve which could be used with the cartridge of FIG. 1;

FIG. 15 is a top plan view of an exemplary base layer of the pressure relief valve of FIG. 14;

FIG. 15A is a top plan view of a further exemplary base layer which could be used in the pressure relief valve of FIG. 14;

FIG. 16 is a section view taken along section 16-16 of FIG. 11 with the pressure relief valve in a first, or closed, position;

FIG. 17 is a section view taken along section 16-16 of FIG. 11 but with the pressure relief valve in a second, or open, position;

FIG. 18 is a perspective view of an exemplary K-Cup-type cartridge including brewer entrance and exit needles;

FIG. 19 is a section view taken along section 19-19 of FIG. 18 showing hot water being injected into the cartridge;

FIG. 19A is an enlarged section view taken along section 19A-19A of FIG. 19 showing hot water within the cartridge and hole and baffle elements of the pressure relief valve;

FIG. 20 is a perspective view of a further exemplary K-Cup-type cartridge which has a configuration different from that of the cartridge of FIG. 1;

FIG. 21 is a top plan view of the cartridge of FIG. 20; and

FIG. 22 illustrates three lid components on a release liner with each lid component having a pressure relief valve.

### DETAILED DESCRIPTION

FIGS. 10-21 illustrate embodiments of improved single-serve cartridges 10, 10a with a one-way gas pressure relief valve 11, referred to herein simply as a “valve.” In the examples, cartridges 10, 10a are K-Cup-type cartridges suitable for use in the Keurig brand Single Cup Brewing System of the type previously described. Valve 11 blocks entry of ambient air into cartridge 10, 10a, permits pressurized gas to escape from within cartridge 10, 10a and yet restricts leakage of coffee and water out of cartridge 10, 10a through valve 11. In effect, the improved cartridge 10, 10a enables improvements in beverage quality while cartridge 10, 10a continues to function in the brewer in the same manner as an undistorted conventional cartridge 1.

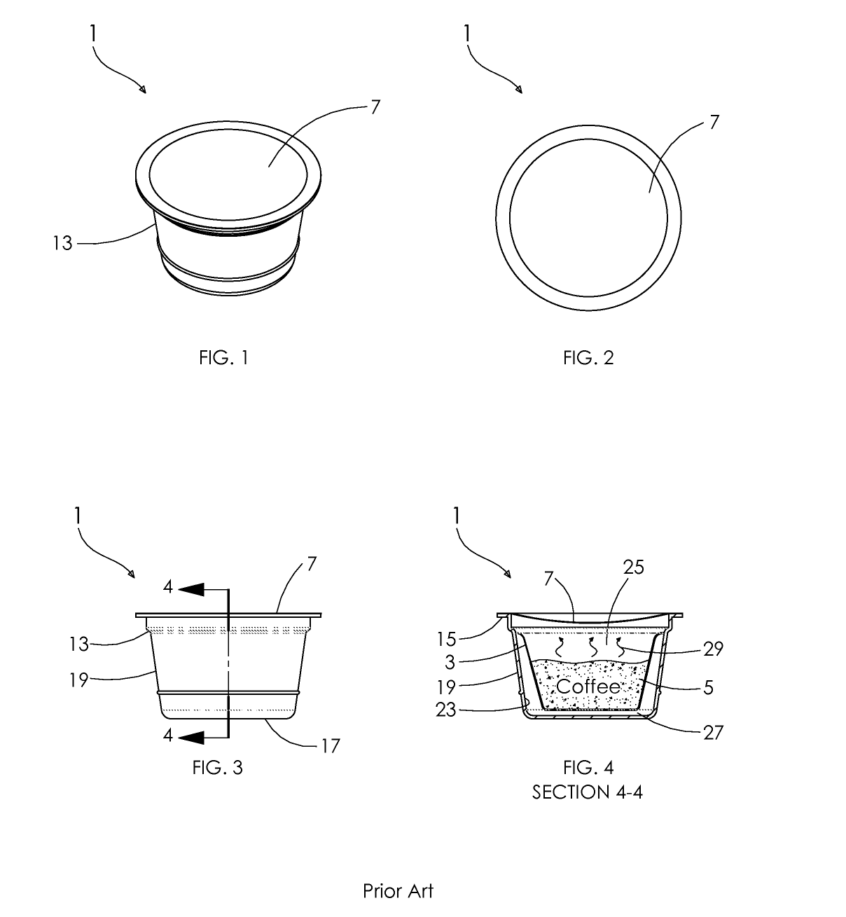

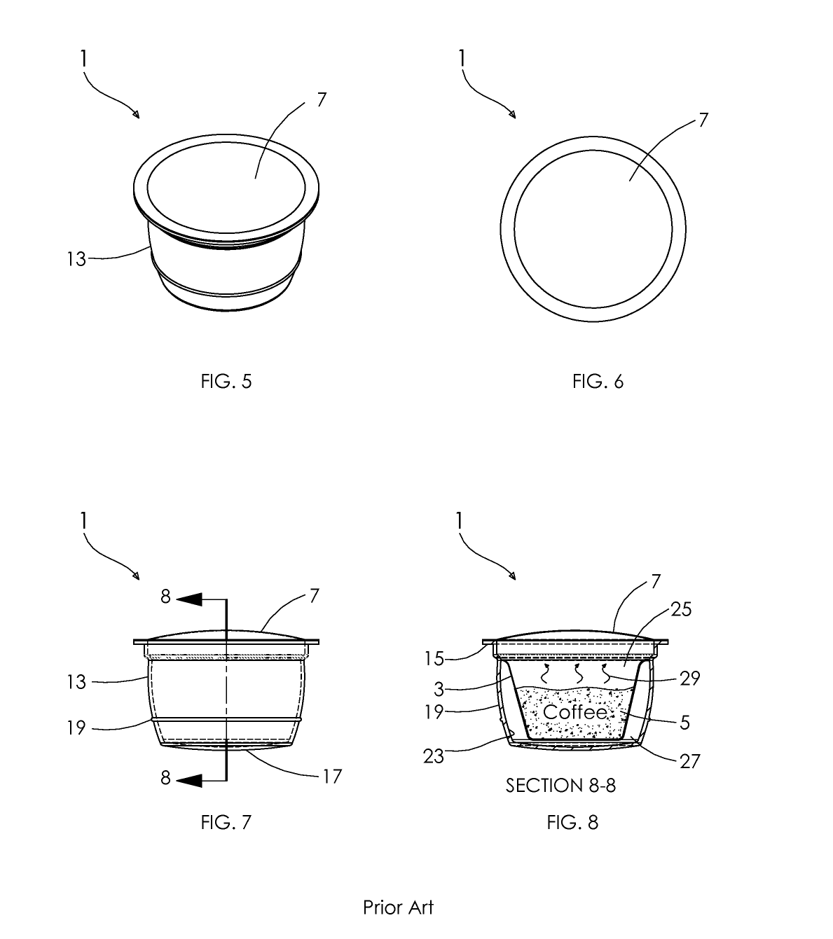

Before describing exemplary cartridge embodiments 10, 10a, an expanded description of the problems inherent in a representative prior art K-Cup-type cartridge 1 is provided. Referring then to FIGS. 1-9A, K-Cup-type cartridge 1 comprises a cup 13 and a lid 7 secured to rim 15 of cup 13, typically by an adhesive (not shown). Cup 13 includes a bottom 17 and a generally cylindrical side wall 19. Cup 13 is typically made of a thin, flexible plastic material while lid 7 is typically made of a foil or a flexible plastic material.

As illustrated in the section views of FIGS. 4 and 8, cartridge 1 includes a cellulosic filter element 3 is within cup 13. In these examples, filter element 3 is joined circumferentially to an inner surface 23 of cup 13 sidewall 19 thereby forming a type of “basket” for holding ground coffee 5 or other particulate beverage medium therein. Cup 13 further defines a head space 25 above the ground coffee 5 held in filter element 3 and a lower space 27 between filter element 3 and cup 13.

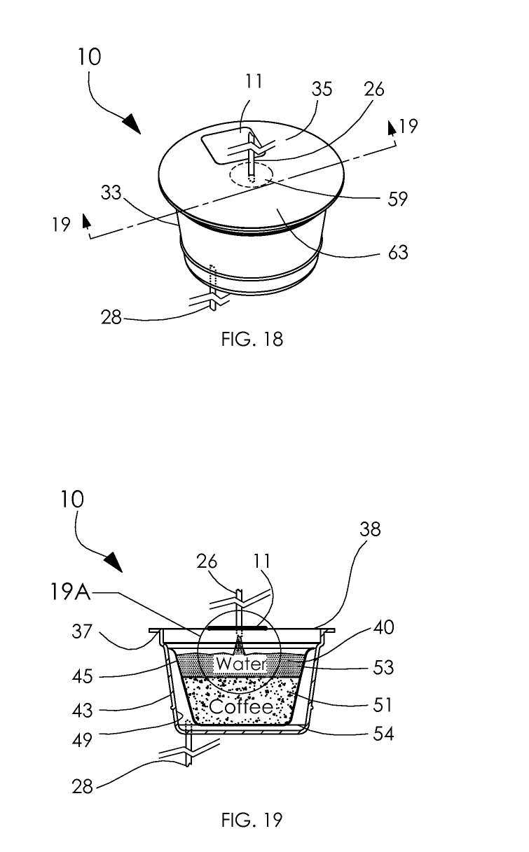

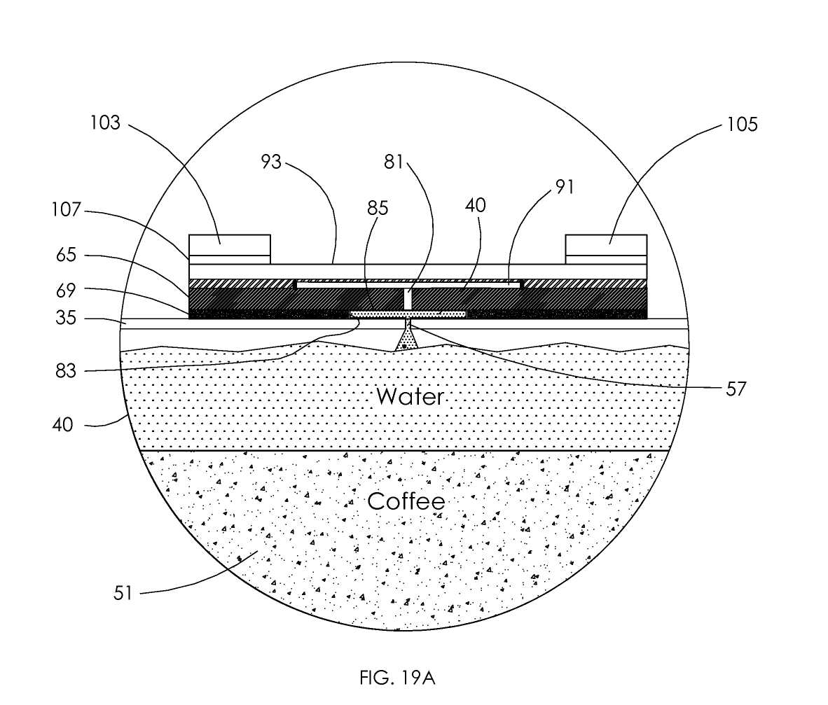

The Keurig Single Cup Brewer (not shown) injects hot water under pressure into the K-Cup-type cartridge 1 loaded in a holder (not shown) within the brewer. The hot water is injected under pressure by means of an entrance needle 26 (example shown in FIGS. 18-19). The K-cup-type cartridge 1 fills with the hot water to brew the coffee or other beverage. The liquid coffee or other beverage filtrate is drained from the K-Cup-type cartridge 1 by means of an exit needle 28 (example shown in FIGS. 18-19). Depending on whether a small or large beverage serving is selected, a volume of about 160 ml to about 220 ml of hot water is injected into the K-Cup-type cartridge 1 by the brewer during the brewing process.

The entrance and exit needles 26, 28 are inserted automatically by the brewer when the brewer handle is lowered with a K-Cup-type cartridge 1 properly seated in the holder. The entrance needle 26 is inserted through lid 7 and into head space 25 and exit needle 28 is inserted through bottom 17 of K-Cup-type cartridge 1 and into lower space 27.

Entrance needle 26 is a hollow cannula-like tube with a sharpened end facing lid 7 and which pierces lid 7. Entrance needle 26 may be a stainless steel needle having a cylindrical bore, a length of approximately 10 mm and a diameter of approximately 4 mm. Lid 7 is of a material which can be pierced by the entrance needle. A gasket (not shown) around entrance needle 26 forms a liquid-tight seal against lid 7 and prevents liquid from exiting K-Cup-type cartridge 1 between entrance needle 26 and lid 7.

Exit needle 28 may be a stainless steel cannula-like needle having a cylindrical bore, a length of approximately 5 mm and a diameter of approximately 4 mm.

In the examples, hot water is injected into head space 25 above filter element 3 and into contact with ground coffee 5 (or other particulate beverage medium). Filtrate (i.e., liquid coffee) from ground coffee 5 passes through filter 3, through exit needle 28 and to a coffee cup (not shown) placed in the brewer.

The problem resulting from carbon dioxide gas released from the ground coffee 5 or other particulate beverage medium can be easily understood by reference to FIGS. 1-9A. Immediately after packaging and sealing of lid 7 to rim 15, K-Cup-type cartridge 1 is in the state represented by FIGS. 1-4 with K-Cup-type cartridge 1 in a state of equilibrium and lid 7 initially bowed inward.

FIGS. 4 and 8 include wavy lines 29 which schematically represent carbon dioxide and other gas generated by ground coffee 5 within K-Cup-type cartridge 1 subsequent to loading in K-Cup-type cartridge 1. The ground coffee 5 continues to produce gas after it is loaded in the K-Cup-type cartridge 1 producing a positive pressure within K-Cup-type cartridge 1. The carbon dioxide gas volume produced by ground coffee 5 is greater still if ground coffee 5 has not first been degassed as previously described. Pressure within the K-Cup-type cartridge 1 can be in excess of seven pounds per square inch (psi).

Referring next to FIGS. 5-8, as the carbon dioxide gas volume and pressure increase, lid 7 and cup 13 of K-Cup-type cartridge 1 expand outwardly as can be understood by comparing FIGS. 5-8 with FIGS. 1-4. The distortion of lid 7 and cup 13 occurs because these components are typically made of thin, lightweight and flexible materials.

The distortion and swelling of cartridge 1, or multiple cartridges 1, can damage or rupture the carton or secondary package (not shown) in which a plurality of cartridges 1 are packaged rendering the carton, or case in which multiple cartons are packed, unsalable as previously described. Also as previously described, swelling of a K-Cup-type cartridge 1 can interfere with seating of cartridge 1 in the brewer and can render cartridge 1 visually unattractive and unsalable as being potentially contaminated with bacteria or microorganisms.

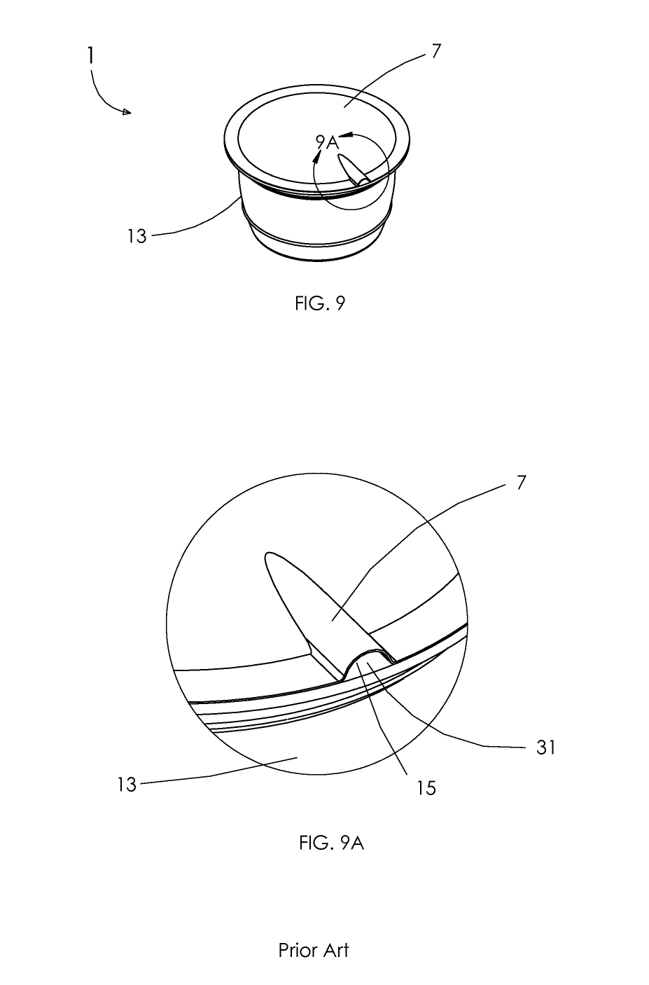

FIGS. 9 and 9A illustrate an extreme circumstance in which force produced by the gas pressure can cause failure of cartridge 1. As illustrated, lid 7 could separate from cup 13 along rim 15 creating an opening 31 in cartridge 1. Opening 31 would allow ambient air or contaminants outside of cartridge 1 to enter cartridge 1 and for ground coffee 5 to escape from cartridge 1 through opening 31. FIG. 9A is an enlarged view illustrating separation of lid 7 from cup 13 and opening 31. The state illustrated in FIGS. 9 and 9A represents a packaging failure in which the integrity of the K-Cup-type cartridge 1 has been lost and cartridge 1 must be discarded.

Referring now to FIGS. 10-21, examples of improved single-serve cartridges 10, 10a with a one-way gas pressure relief valve 11 (“valve”) will next be described. The improved single-serve cartridges 10, 10a with valve 11 relieve gas pressure produced by ground coffee 5 (or other particulate beverage medium) therein, thereby permitting ground coffee 5 to be packaged in cartridges 10, 10a immediately after roasting and grinding and without any requirement for substantial degassing before packaging in cartridges 10, 10a. Single-serve cartridges 10, 10a as described herein provide for improved coffee flavor and an improved coffee experience for the consumer. Improved valve 11 of cartridges 10, 10a enables such cartridges 10, 10a to function in a brewer in the same manner as a conventional undistorted cartridge, thereby permitting cartridge 10, 10a to be used in an unmodified brewer.

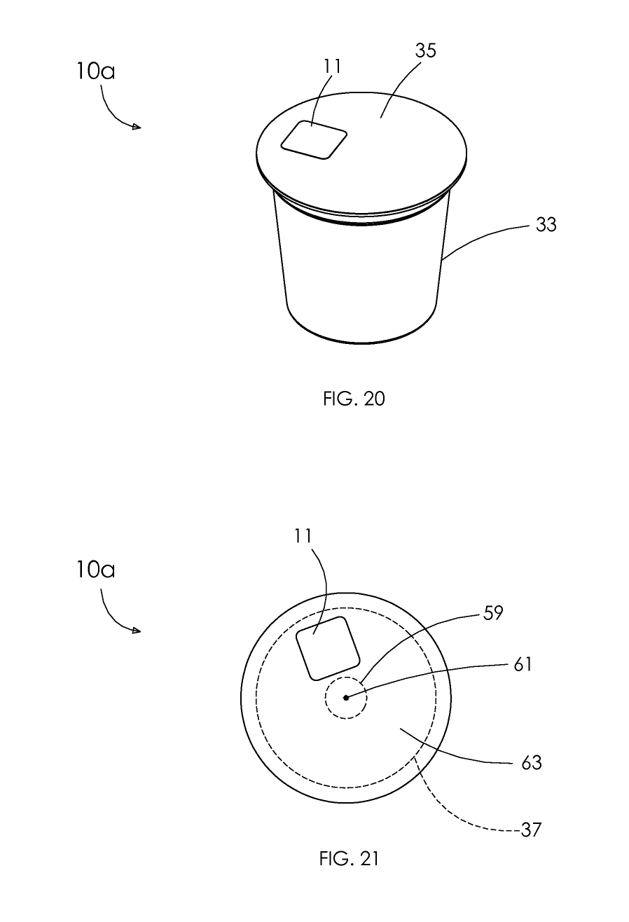

As previously described, cartridges 10, 10a illustrated in FIGS. 10-21 are non-limiting examples of K-Cup-type cartridges suitable for use with a Keurig Single Cup Brewer described previously, but can be configured for use in other beverage systems. The configurability of cartridges 10, 10a is illustrated by cartridge 10a in FIGS. 20-21 which has a configuration which is larger and more elongate than that of cartridge 10 to accommodate use in a Keurig or other suitable beverage system. Cartridges 10, 10a are otherwise identical and the description of cartridge 10 is incorporated by reference with respect to cartridge 10a.

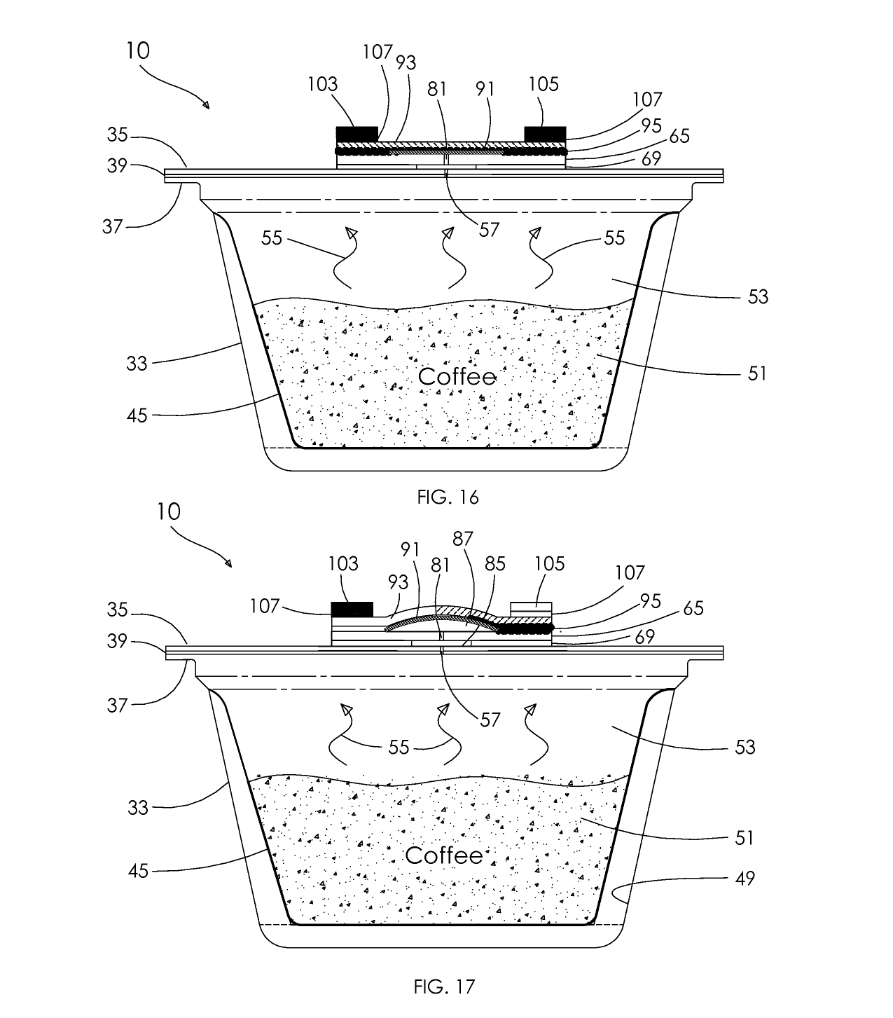

Referring then to FIGS. 10-19A, cartridges 10, 10a each preferably comprise a cup 33, and a lid 35 secured to rim 37 around top 38 of cup 33, preferably by adhesive 39 (FIGS. 16-17). Cup 33 is a type of container. Cup 33 preferably includes a bottom 41 and a side wall 43 which may be tapered (i.e., narrowed) toward bottom 41 as illustrated in FIGS. 12-13, 16-17 and 19. While tapered cups 33 are illustrated, any suitable configuration for cups 33 may be utilized. Cup 33 is preferably made of a thin, flexible plastic material while lid 35 is preferably made of a flexible foil or flexible plastic material. The material(s) selected for construction of lid 35 and cup 33 are preferably selected such that lid 35 may be pierced by entrance needle 26 of the brewer as described previously and such that cup 33 is self-supporting, impermeable to air and liquid, and is piercable by exit needle 28 of the brewer also as described previously (FIGS. 18-19).

Referring next to FIGS. 13 and 16-17, exemplary cartridges 10, 10a, may include a filter element 45 within cup 33. Filter element 45 may be made of a suitable material such as cellulosic material or polypropylene. Filter element 45 may be joined circumferentially to cup sidewall 43 inner surface 49. In the examples, filter element 45 provides a type of “basket” for holding ground coffee 51 or other particulate beverage medium therein.

Persons of skill in the art will appreciate that a filter element with a structure other than filter element 45 may be implemented for use with cartridge 10, 10a. And, certain cartridge 10, 10a embodiments may not include a filter element 45, for example if the beverage medium is a water-soluble material.

A head space 53, above filter element 45 in the examples, is preferably provided. A lower space 54, below filter element 45 in the examples, is also preferably provided. As illustrated in FIGS. 13 and 16-17, ground coffee 51 produces carbon dioxide and other gases as represented schematically by wavy lines 55 originating from ground coffee 51.

While the improvement is described in connection with ground coffee 51, it is to be understood that the improvement is applicable to any particulate beverage medium which produces gas.

Referring further to FIGS. 10-21, valve 11 is affixed to a cartridge 10, 10a over vent 57 in lid 35 to allow for discharge of carbon dioxide gas or other gases (represented by wavy lines 55) from within cartridge 10, 10a and out to the environment outside of cartridge 10, 10a. Each cartridge 10, 10a including valve 11 provides a hermetically-sealed package which protects the freshness and quality of the ground coffee 51 or other particulate beverage medium therein.

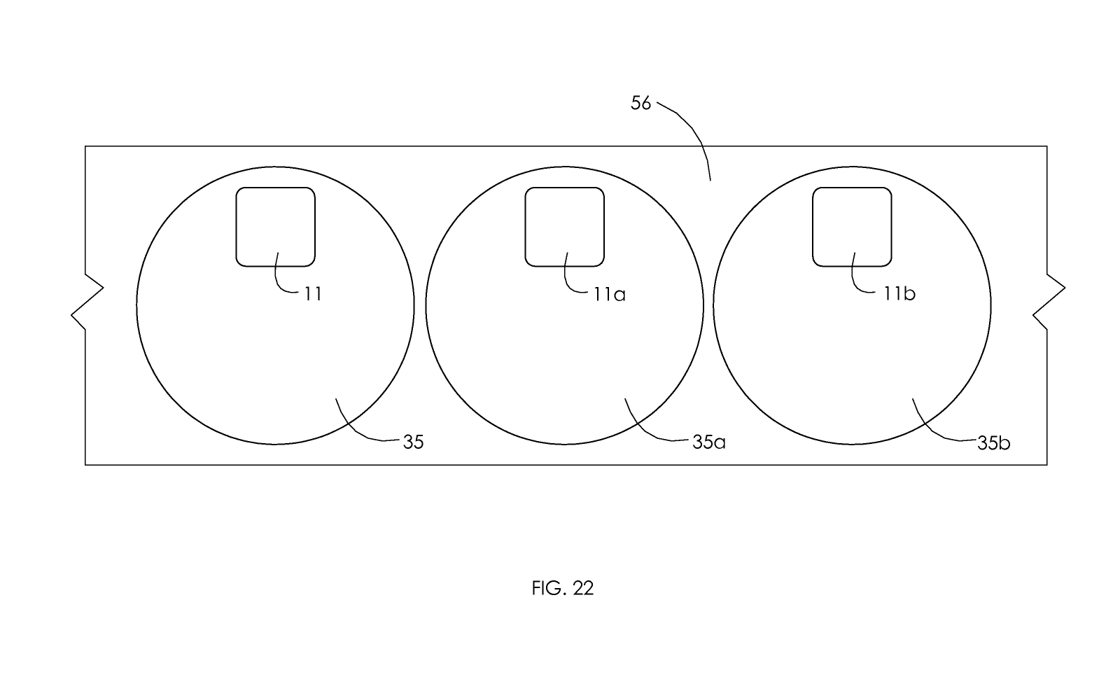

Valve 11 may be affixed directly to a lid 35 of a sealed cartridge 10, 10a over vent 57 following loading of roasted and ground coffee 51 into the cartridge 10, 10a. In other embodiments, valve 11 may be applied to lid 35 before lid 35 is attached to cup 33 providing a combined lid 35 and valve 11 which may be supplied as a cartridge component. FIG. 22 illustrates such an embodiment. As illustrated in FIG. 22, a release liner 56 carries three lids 35, 35a, 35b. An adhesive (not shown) holds lids 35, 35a, 35b on release liner 56. Lids 35, 35a, 35b may be die cut and the valves 11, 11a and 11b applied to the lids over vent 57 in one of more manufacturing steps. The combined lid-and-valve component may then be attached around cup 33 rim 37 by adhesive 39 or other suitable means to provide a completed cartridge 10, 10a ready to be used in a brewer to brew a cup of coffee or other beverage.

An advantage of providing lids 35-35b as pre-manufactured components is that the valve manufacturer can better control quality of the valves 11 and attachment to the lids 35-35b. A further advantage of providing lids 35-35b as pre-manufactured components is that the lids 35-35b can be supplied to the roaster as finished components. The roaster can then apply lids 35-35b to cups 33 using the roaster's conventional packaging equipment without any need for specialized equipment to apply the valve 11 to lid 35.

As discussed below, valve 11 is constructed to prevent air and contaminants outside of cartridge 10, 10a from entering valve 11 and cartridge 10, 10a. Valve 11 also allows positive pressure from within cartridge 10, 10a to escape, thereby preventing cartridge 10, 10a from swelling and becoming distorted. And, valve 11 is constructed to prevent hot water 40 injected through entrance needle 26 and any pressurized liquid coffee or beverage filtrate from leaking through valve 11, potentially spilling onto the brewer and surfaces surrounding the brewer causing a mess which must be cleaned up. Escape of such hot water 40 and/or liquid coffee through pressure relief valve 11 could also cause the brewer to malfunction or could flow into the user's cup beneath cartridge 10, 10a diluting the coffee or other beverage.

Valve 11 is preferably affixed to lid 35 because lid 35 provides a relatively smooth and generally flat surface which facilitates adhesion and attachment of valve 11 to lid 35. In other embodiments, valve 11 may be affixed to bottom 41 of cup 33, or to any other part of cartridge 10, 10a which does not interfere with operation of the brewer.

In the examples, valve 11 is mounted on cartridge 10, 10a at a location which will not interfere with penetration of brewer entrance needle 26 or brewer exit needle 28 into cartridge 10, 10a. Entrance needle 26 of a Keurig brewer can puncture a hole in lid 35 which is as large as about 0.25 inches in diameter. Given the large size of the puncture, it is desirable that there be no contact between entrance needle 26 and valve 11. In certain embodiments, it may be important that valve 11 is spaced from entrance and exit needles 26, 28 because the material used to manufacture valve 11 may be tougher than the material used to manufacture lid 35 and cup 33. Consequently, the brewer entrance 26 and exit needles 28 might not be capable of piercing through valve 11. As a further example, force applied to valve 11 might separate lid 35 from cup 33 around rim 37 or tear lid 35 before entrance needle 26 were to penetrate valve 11 and lid 35. This could cause cartridge 10, 10a to leak during the brewing process.

For embodiments in which valve 11 is affixed to lid 35, it has been determined that the attachment position should be offset, preferably entirely offset, from the location of lid 35 where the brewer entrance needle 26 pierces lid 35 to inject hot water into cartridge 10, 10a for brewing the coffee or other beverage as described previously. By entirely offsetting valve 11 from lid 35 contacted by the entrance needle 26, it is ensured that entrance needle 26 will be able to easily penetrate through lid 35 as presently occurs with cartridges 1.

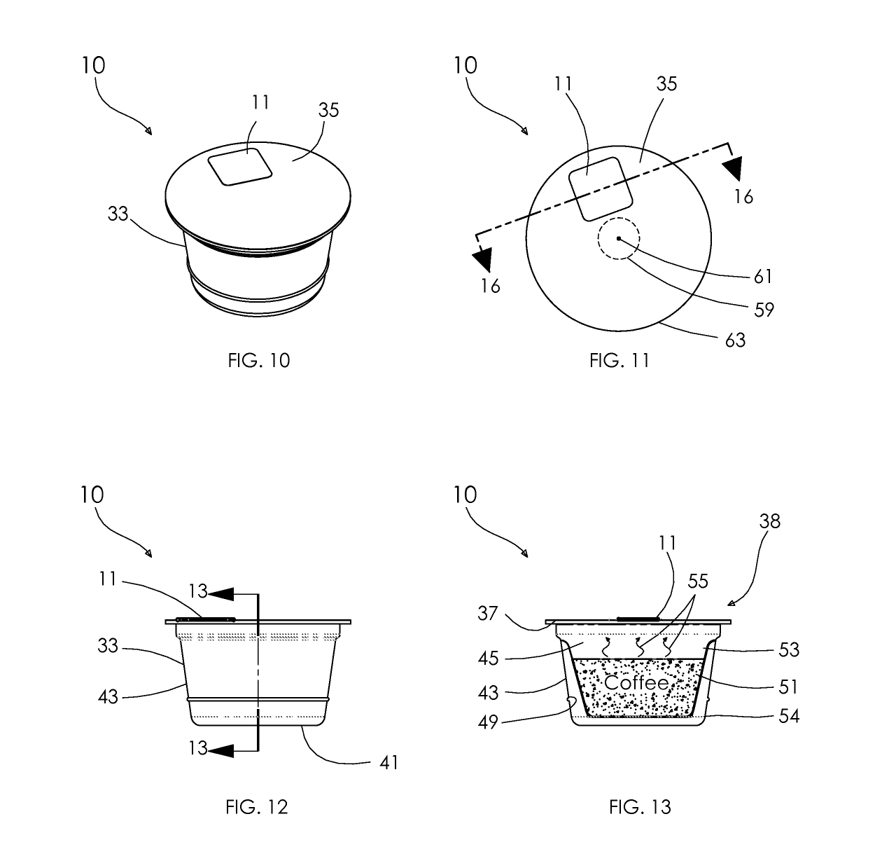

An exemplary location of valve 11 on lid 35 entirely offset from the location where entrance needle 26 penetrates lid 35 may be understood by reference to FIGS. 11, 14, 18-19 and 21. In these examples, lid 35 is generally circular. A Keurig Single Cup Brewer inserts entrance needle 26 through a “puncture zone” 59 which may be located radially outward from center 61 of lid 35. In the examples, a “valve placement zone” 63 is located radially outward from puncture zone 59. Valve placement zone 63 means or refers to any location or zone on cartridge 10, 10a that is totally out of a path of entrance needle 26 or exit needle 28. Valve 11 may be located anywhere within valve placement zone 63 and placement within such zone will effectively offset valve 11 from puncture zone 59, thereby ensuring that brewer entrance needle 26 will penetrate through lid 35 without interference from valve 11.

By way of non-limiting example and as illustrated in FIGS. 11, 14, 18-19 and 21, cartridge 10, 10a for use with a Keurig brewer may have a circular lid 35 (in plan view) with a diameter of about 1.75 inches to about 2 inches. In such an example, puncture zone 59 may be a circle having a diameter of about 0.5 inch concentric with center 61 of lid 35. In the example, valve placement zone 63 may be anywhere on lid 35 other than puncture zone 59.

In such an example, valve 11 may have a generally rectangular footprint, or land area, as illustrated in FIGS. 11, 14, 18 and 21 with valve 11 having a length (L) dimension of about 0.5 inch and a width (W) dimension of about 0.5 inch. Such an exemplary rectangular valve 11 would fit entirely within valve placement zone 63 offset from puncture zone 59 as illustrated in FIGS. 11, 14, 18 and 21. Such an exemplary rectangular valve 11 would represent a valve having a footprint, or land area, configuration much smaller than the area of a typical rectangular pressure-relief valve (not shown) which has length (L) dimension of about 0.787 inch and a width (W) dimension of about 0.787 inch. Such a typical pressure-relief valve would be less advantageous for use with a lid 35 of a K-Cup-type cartridge 10, 10a because such a valve could more easily block and interfere with penetration of brewer entrance needle 26 through lid 35.

The foregoing examples are merely representative. Persons of skill in the art will appreciate that puncture zone 59 may be located other than as illustrated in FIGS. 11, 14, 18 and 21. Persons of skill in the art will further appreciate that valve 11 may have a configuration other than as a rectangle (e.g., a triangle, a pentagon, a polygon, an oval, a circle, etc.) and may be located anywhere on cartridge 10, 10a which does not interfere with operation of the brewer.

Referring again to FIGS. 10-22, there are illustrated embodiments of exemplary one-way gas pressure relief valves 11 for use with cartridge 10, 10a. Exemplary valve 11 may include a base layer 65 in combination with a flexible seal 67. Base layer 65 and flexible seal 67 regulate one-way gas flow through valve 11 and make valve 11 essentially “liquid-tight” with respect to hot water 40 injected into cartridge 10, 10a and any resultant liquid coffee or other beverage. Essentially liquid-tight means or refers to a valve which limits liquid passage through valve 11 under the pressure at which hot water 40 is injected into cartridge 10, 10a by the Keurig brewer or other coffee brewing devices. Essentially liquid-tight contemplates that a very small volumetric amount of liquid, such as a drop or two of liquid, could be expelled through valve 11. Such a small amount of liquid outflow from valve 11 would be acceptable because such small liquid volume would not create a mess or dilute the coffee or other beverage. Valve 11 allows cartridge 10, 10a to function in the brewer in the same manner as a conventional and unmodified cartridge, such as cartridge 1.

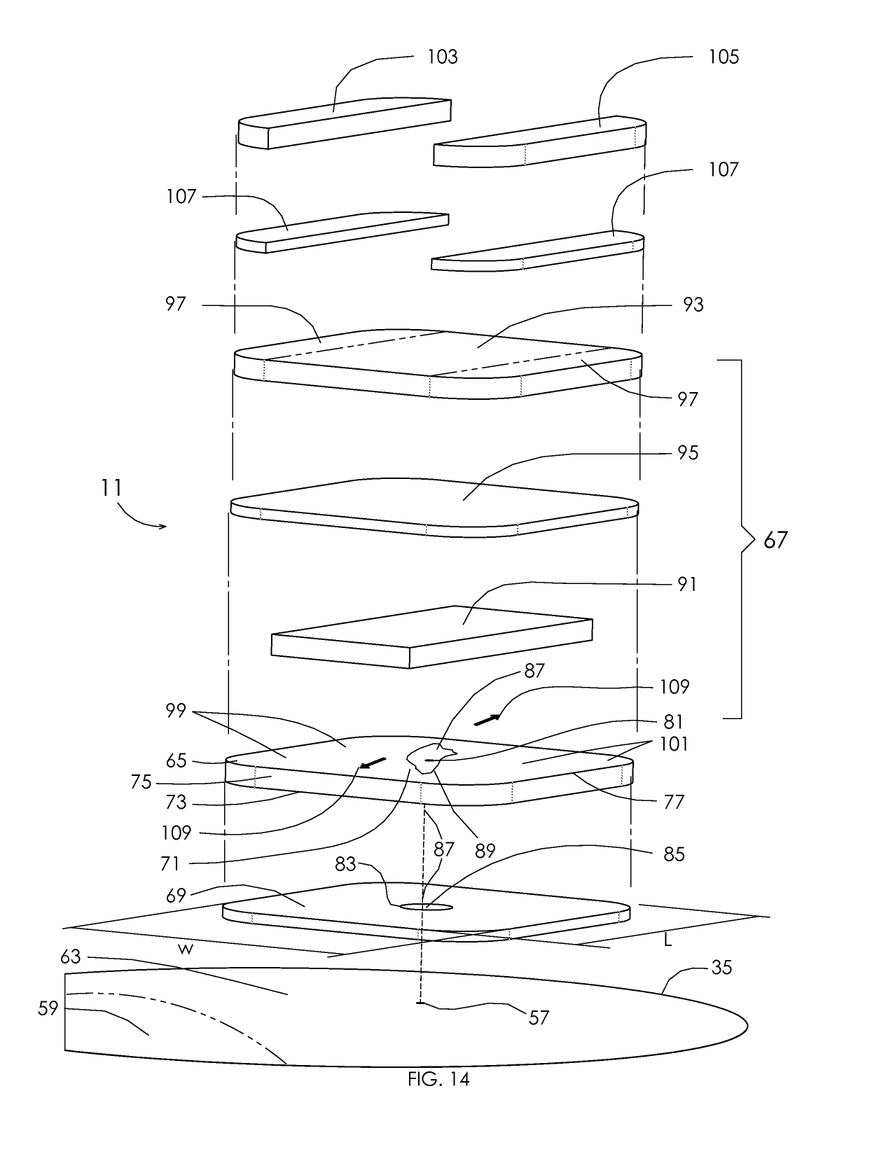

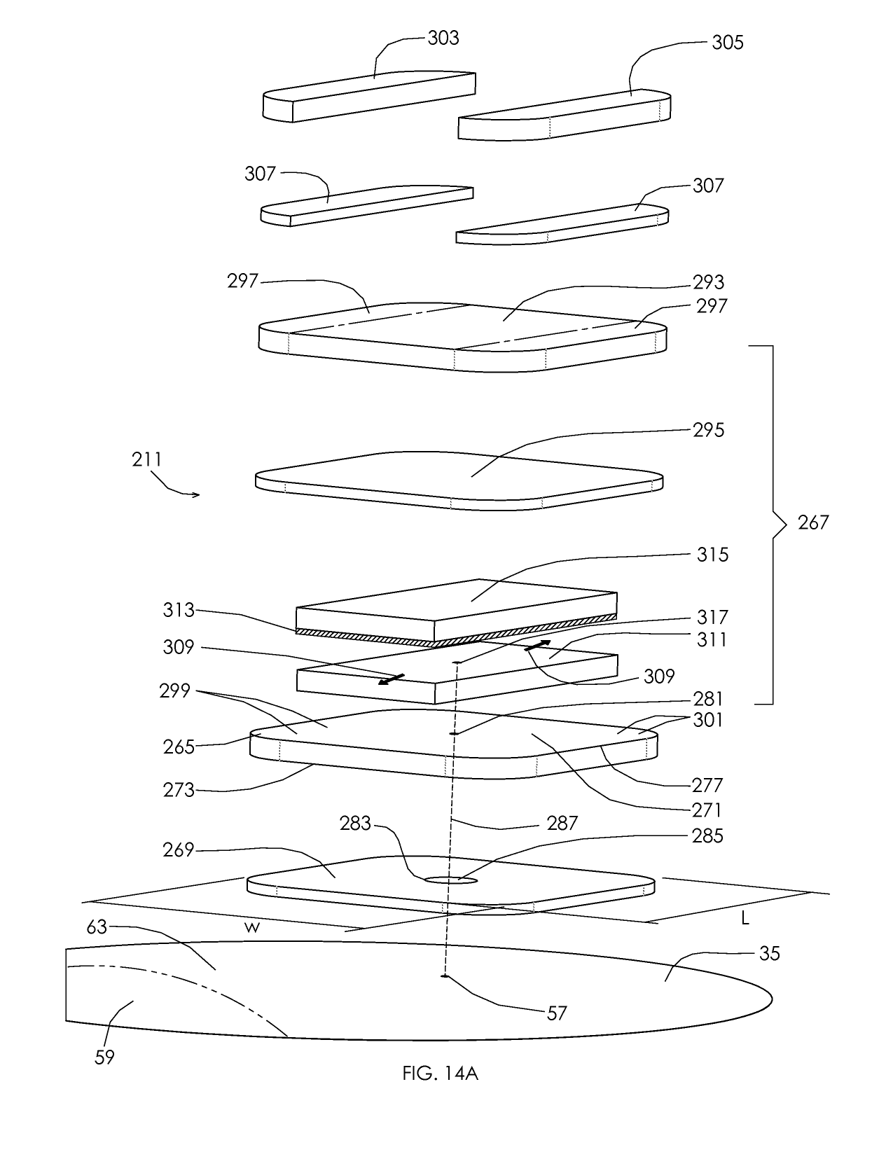

Referring to FIGS. 14-17, base layer 65 provides a platform on which valve 11 is constructed and is preferably attached to lid 35 within valve placement zone 59 by adhesive layer 69 on second side 73 of base layer 65. Base layer 65 is positioned over vent 57 which is preferably on lid 35 and within valve placement zone 63. Vent 57 may be any suitable opening or openings through lid 35 permitting gas movement through lid 35 and out of cartridge 10, 10a.

In the example, vent 57 is a single hole in lid 35. In embodiments, the single hole of vent may be punched in lid 35 during die cutting of lid 35. In other embodiments, vent 57 includes plural openings entirely through lid 35. In embodiments, vent 57 has a total cross-sectional area (in a plane defined by lid 35) of less than about 0.00019 in². Such cross-sectional area could be the area of a single vent 57 or the total area of a plurality of vents 57. A smaller cross-sectional area of vent 57 is preferred because a relatively small vent 57 will restrict flow of hot water 40 injected into cartridge 10, 10a and restrict liquid coffee. While such a small vent 57 will restrict flow of hot water 40 and/or liquid coffee, it will allow carbon dioxide gas flow therethrough because gas is less dense than liquid such as hot water 40 or liquid coffee.

Base layer 65 includes first and second sides 71, 73, a periphery 75, a body 77 between sides 71, 73 and at least one hole 81 entirely through body 77. Base layer 65 is generally flat, or planar, and may be made of materials that will not degrade during momentary contact with hot water 40, liquid coffee or beverage filtrate during the brewing process. Base layer 65 should be impervious to gas flow. Representative materials for use in base layer 65 include polyethylene, polypropylene, polyethylene terephthalate, biodegradable polylactic acid, cellulose acetate, or any other suitable material or materials. Base layer 65 may have a thickness in the range of about 0.25 mils to about 50 mils depending on the application.

Referring to FIGS. 14-17, exemplary base layer 65 defines at least one hole 81 which provides one type of gas flow opening entirely through body 77. Hole 81 may be formed in base layer 65 by laser drilling, punching, or any suitable method and may be sized and arranged based on gas flow requirements. In the embodiment of FIGS. 14-15 and 16-17, hole 81 has a total cross-sectional area (in a plane defined by base layer 65) of less than about 0.000314 in². Hole 81 should not exceed this cross-sectional area because a hole 81 with a cross-sectional area greater than this amount would enable excessive amounts of hot water 40 and/or liquid coffee or other beverage to leak through hole 81 and valve 11.

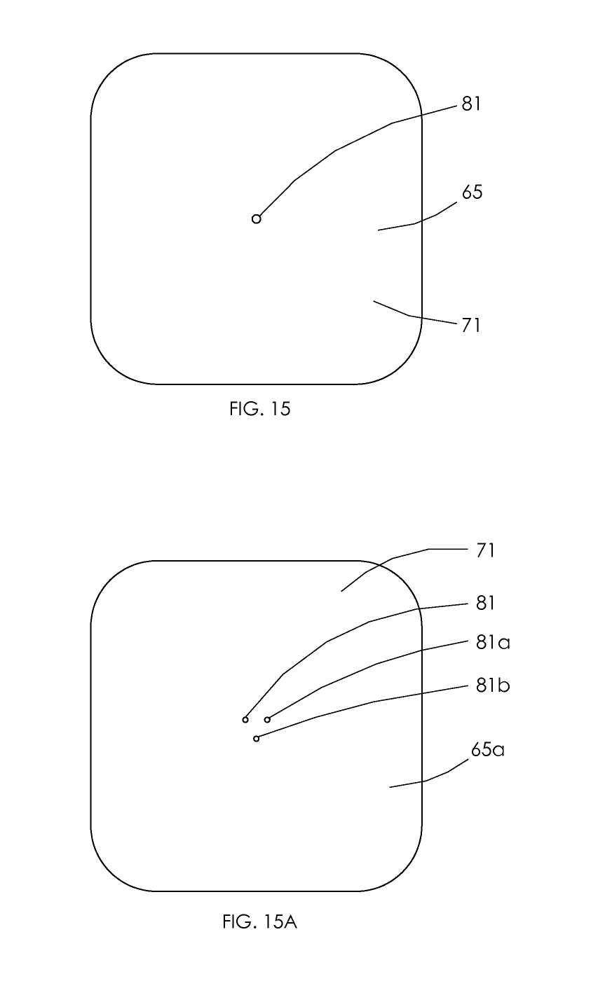

Referring to FIG. 15A, a base layer 65a for use in other valve 11 embodiments may include plural holes in place of a single hole 81, three plural holes 81, 81a, 81b being shown in the example. For embodiments including plural holes 81, 81a, 81b, the total cross-sectional area (in a plane defined by base layer 65) of holes 81, 81a and 81b should collectively be less than about 0.000314 in². Holes 81-81b should not exceed this cross-sectional area because holes 81-81b with a collective cross-sectional area greater than this amount would enable hot water 40 and/or liquid coffee or other beverage to leak through such holes 81-81b and valve 11.

Referring FIGS. 14 and 16-17, adhesive layer 69 is provided on base layer 65 second side 73 to removably mount base layer 65 on a release liner (not shown) after manufacture and to permanently attach base layer 65 and valve 11 to lid 35 of cartridge 10, 10a. In the example, adhesive layer 69 may be about 0.25 mils to about 15 mils in thickness. Adhesive layer 69 should be impervious to gas flow and sufficiently impervious to liquid (i.e., hot water 40, liquid coffee) to prevent gas and liquid leakage between base layer 65 and lid 35. Suitable adhesives for adhesive layer 69 may include pressure-sensitive and heat-activated adhesives. Rubber-based, silicone and acrylic adhesives may be utilized as adhesive layer 69.

Referring further to FIGS. 14 and 16-17 and 19A, adhesive layer 69 is deposited across base layer 65 second side 73. Adhesive layer 69 has an inner edge 83 surrounding hole 81, or plural holes 81, 81a, 81b, to define with base layer 65 second side 71, a liquid flow-restricting baffle 85. Baffle 85 is in gas-flow communication with hole 81. When valve 11 is attached to lid 35, baffle 85 is positioned over vent 57.

Baffle 85 provides a space, or buffer, which holds and stores hot water 40 injected into cartridge 10, 10a by the brewer through entrance needle 26 and any liquid coffee which may enter baffle 85 through vent 57. Baffle 85 limits hot water 40 and/or liquid coffee flow through hole 81 by reducing the pressure of hot water 40 and/or liquid coffee which may enter baffle through vent 57. Baffle 85 is particularly effective at minimizing or modulating the momentary high pressure of hot water 40 (i.e., a type of water hammer) as such water fills cartridge 10, 10a after injection into cartridge 10, 10a through entrance needle 26 as described below.

Referring again to FIGS. 14, 16-17 and 19A, the components comprising flexible seal 67 of valve 11 provide a type of “gate” or “closure” enabling valve 11 to be placed in a closed state and, alternatively, in an open state. In the closed state illustrated in FIGS. 16 and 19A, flexible seal 67 is in a first position and valve 11 is sealed blocking entry of ambient air into valve 11 and cartridge 10, 10a and preventing hot water 40 and/or liquid coffee (or other liquid) from leaking out of valve 11 through hole 81. In the open state illustrated in FIG. 17, flexible seal 67 is in a further position in which valve 11 permits one-way gas flow out from cartridge 10, 10a, through gas flow path 87 and to the environment.

Valve 11 opens and closes to allow carbon dioxide gas outflow from cartridge 10, 10a based on pressure differential between pressure inside cartridge 10, 10a and pressure outside cartridge 10, 10a. Valve 11 may be designed to open with any desired target pressure differential. Selection of materials with appropriate resiliency is one manner of engineering valve 11 to open at a desired pressure differential. An opening target pressure differential may be less than about 0.2 psig greater pressure inside cartridge 10, 10a than outside cartridge 10, 10a. Valve 11 may be designed to close when pressure inside cartridge 10, 10a exceeds pressure outside cartridge 10, 10a by about 0.008 psig or less. Other target opening and closing pressures may be utilized and the foregoing are merely non-restrictive examples.

Referring to the exploded view of FIG. 14, flexible seal 67 has a structure which can be wetted with a wetting fluid 89 to obtain optimal adhesion between strap, or closure 91, and base layer 65 first side 71. Wetting agent 89 may, for example, comprise a food-grade oil, a silicone impregnated lubricating oil, a graphite impregnated lubricating oil and combinations thereof. Wetting agent 89 may, for example, be introduced into valve 11 during valve manufacture. Wetting agent 89 improves surface adhesion between base filter layer 65 first side 71 and closure 91 improving formation of a gas-tight seal when valve 11 is in the closed state.

In the example, flexible seal 67 includes closure 91 (also referred to in industry as a “dry strap” or simply “strap”), cover membrane 93, and an adhesive layer 95 joining cover membrane 93, or layer, to closure 91 and selectively joining cover membrane 93 shoulders 97 (outer regions of cover membrane 91 in the example) to attachment regions 99, 101 of base layer 65 first side 75. As previously described, “selective joining” means or refers to joining of cover membrane 93 only to attachment regions 99, 101 of base layer 65 and not to base layer 65 between such attachment regions 99, 101. Because cover membrane 93 is unjoined to base filter layer 65 where closure 91 is secured to cover membrane 93 between attachment regions 99, 101, cover membrane 93 is permitted to flex and move slightly away from base layer 65 (caused by the pressure differential) along the unjoined regions when in the open state to permit gas flow out of valve 11. When the unjoined portion of cover membrane 93 moves away from base layer 65, closure 91 also moves at least partially away from base layer 65. Accordingly, cover membrane 93 of the example is a type of flexible cover membrane 93. This opening of valve 11 can be understood by comparing FIGS. 16-17, which are schematic drawings not necessarily to scale.

Flexible seal 67 also applies a force which closes hole 81 to prevent ambient air from entering hole 81, valve 11 and cartridge 10, 10a when in the closed state. Such force also contributes to closure of hole 81 to prevent hot water 40 injected into cartridge 10, 10a by the brewer and liquid coffee from leaking out of cartridge 10, 10a through hole 81. Wetting fluid 89 enhances securement of closure 91 across hole 81.

In the examples, gas flow path 87 extends through baffle 85 and hole 81 through base layer 65 body 77. Along base layer 65 first side 71, gas flow path 87 is bounded by base layer 65 first side 71, closure 91 (adhered to cover membrane 93 by adhesive 95 in the example), and shoulders 97 of cover membrane 93 selectively joined to base layer 65 by adhesive 95 along attachment regions 99, 101. Exemplary gas flow path 87 permits gas outflow from cartridge 10, 10a and through valve 11.

As is illustrated in FIG. 14, closure 91 extends generally across the length (L) of valve 11, but is generally narrower than the width (W) of valve 11. In other words, closure 91 may be located between shoulders 97 as in the example. This arrangement prevents cover membrane 93 from being adhered to base layer 65 by adhesive 95. This, in turn, permits cover membrane 93 to flex to open valve 11.

Closure 91 is secured to cover membrane 93 by adhesive layer 95. Closure 91 prevents adhesive layer 95 from contacting filter layer 65 where it is unjoined with cover membrane 93 between attachment regions 99, 101. Adhesive layer 95 joins cover membrane 93 to base layer 65 attachment regions 99, 101. Exemplary adhesive layer 95 is a gas-impervious pressure-sensitive adhesive layer 95 which may be about 0.25 mils to about 15 mils in thickness. Adhesive layer 95 may be of the same adhesive used for adhesive layer 69.

Cover membrane 93 may be selectively joined to base layer 65 by means other than adhesive layer 95. For example, cover membrane 93 could be selectively joined to base layer 65 by means of sonic welding.

Representative materials for use in closure 91 and cover membrane 93 may include polyethylene, polypropylene, polyethylene terephthalate, biodegradable polylactic acid, cellulose acetate, or any other suitable material or materials. Closure 91 and cover membrane of flexible seal 67 should be impervious to gas flow and sufficiently impervious to liquid (i.e., hot water 40, liquid coffee) to prevent gas and liquid leakage therethrough. Closure 91 and cover membrane 93 may each have a thickness of about 0.25 mils to about 50 mils.

Referring to FIGS. 14 and 16-17, optional bumpers (also referred to as rails) 103, 105 may be joined to cover membrane 93 by an adhesive 107. If provided, bumpers 103, 105 are useful to provide separation between the unjoined portion of cover membrane 93 and any adjacent object such as another cartridge (e.g., cartridge 10, 10a) or the carton or secondary package in which a cartridge 10, 10a is packaged so that closure 91 can freely move away from base layer 65 permitting valve 11 gas flow path 87 to open. Bumpers 103, 105 may be of polyethylene, polypropylene, polyethylene terephthalate, biodegradable polylactic acid, cellulose acetate, or any other suitable material or materials and may have a thickness of about 0.25 mils to about 50 mils. Adhesive 107 may be of the same material as adhesives 69 and 95.

FIG. 14A illustrates an alternative embodiment of a valve 211 for use with cartridge 10, 10a. Valve 211 permits gas outflow yet limits liquid outflow from a cartridge 10, 10a. Valve 211 differs from valve 11 primarily in that valve 211 flexible seal 267 includes first and second layers 311, 313 which are releasably held together to block ambient air from entering cartridge 10, 10a yet are separable sufficiently to allow one-way gas flow out of cartridge 10, 10a. The force of gas pressure from within cartridge 10, 10a separates first and second layers 311, 313 sufficiently to allow the gas outflow from cartridge 10, 10a. The first and second layers 311, 313 contribute to closure of valve 211 without use of a wetting agent as described below.

Referring then to FIG. 14A, valve 211 includes a base layer 265 which may have the same structure and be of the same material as base layer 65 described previously. Base layer 265 includes first and second sides 271, 273, a periphery 275 and a body 277. Body should be of a material impervious to gas flow and sufficiently impervious to liquid (i.e., hot water 40, liquid coffee) so as to prevent liquid leakage through base layer 265 during the brewing process. Base layer 265 may have a thickness in the range of about 0.25 mils to about 50 mils depending on the application.

In the example of FIG. 14A, base layer 265 defines at least one hole 281 which is a type of gas flow opening entirely through body 277. Hole 281 may be formed in base layer 265 by laser drilling, punching, or any suitable method and may be sized and arranged based on gas flow requirements. In the embodiment of FIG. 14A, hole 281 has a total cross-sectional area (in a plane defined by base layer 265) of less than about 0.000314 in². Hole 281 should not exceed this cross-sectional area because a hole 281 with a greater cross-sectional area would enable excessive amounts of hot water 40 and/or liquid coffee to leak through valve 211.

Base layer 265 is not limited to a single hole 281 and plural holes could be used in place of single hole 281, for example in the same manner as holes 81, 81a, 81b described in connection with FIG. 15A above. For an embodiment with plural holes (e.g., holes 81, 81a, 81b), the total cross-sectional area (in a plane defined by base layer 265) of such holes should collectively be less than about 0.000314 in² to avoid hot water 40 and/or liquid coffee leakage through the plural holes (e.g., holes 81, 81a, 81b) and valve 211.

Referring again to FIG. 14A, adhesive layer 269 is provided on base layer 265 second side 273 to removably mount base layer 265 on a release liner (not shown) after manufacture and before attachment to a lid 35. Adhesive layer 269 also permanently attaches base layer 265 and valve 211 to lid 235 of cartridge 10, 10a. In the example, adhesive layer 269 may be about 0.25 mils to about 15 mils in thickness. Adhesive layer 269 should be of a material impervious to gas flow and sufficiently impervious to liquid (i.e., hot water 40, liquid coffee) to prevent gas and liquid leakage between base layer 265 and lid 35 during the brewing process. Suitable adhesives for adhesive layer 269 may include pressure-sensitive and heat-activated adhesives. Rubber-based, silicone and acrylic adhesives may be utilized as adhesive layer 269.

In the example, adhesive layer 269 is deposited across base layer 265 second side 273. Adhesive layer 269 has an inner edge 283 surrounding hole 281 (or plural holes such as holes 81, 81a, 81b), to define, with base layer 265 second side 273, a liquid flow-restricting baffle 285. Baffle 285 is in gas-flow communication with hole 281. When valve 211 is attached to lid 35, baffle 285 is positioned over vent 57 through lid 35.

Baffle 285 provides a space, or buffer, which holds and stores hot liquid coffee 40 which may pass through vent 57 during the brewing process. Accordingly, baffle 285 contributes to restriction of liquid coffee 40 in the same manner as baffle 85 and the description of baffle 85 structure and operation is incorporated herein by reference.

In the example, flexible seal 267 comprises a first layer 311 on base layer first side 271, a second layer 313 on membrane 315, a cover membrane, or layer, 293 and an adhesive layer 295 joining membrane 315 to cover membrane 293. Adhesive layer 295 also selectively joins cover membrane 293 shoulders 297 (i.e., outer regions of cover membrane 293 in the example) to attachment regions 299, 301 of base layer 265. As with valve 11, “selective joining” means or refers to joining of cover membrane 293 only to attachment regions 299, 301 of base layer 265 and not to base layer 265 between attachment regions 299, 301. Because cover membrane 293 is unjoined to base layer 265 between attachment regions 299, 301, cover membrane 293 is permitted to flex and move sufficiently away from base layer 265 along the unjoined region when in the open state to permit gas flow out of pressure relief valve along gas flow path 287. Accordingly, cover membrane 293 can be characterized as a flexible cover membrane 293.

In the example of FIG. 14A, first layer 311 is affixed to base layer 265 atop base layer 265 first side 271 around base layer hole 281. First layer 311 defines a hole 317 in alignment and gas-flow communication with base layer hole 281 to define a portion of gas flow path 287.

Cover membrane 293 and membrane 315 secured to cover membrane 293 are over first layer 311 and holes 281, 317. In the example, second layer 313 is a coating deposited on a surface of membrane 315 facing first layer 311. Membrane 315 with second layer 313 facing first layer 311 covers holes 281, 317 to block gas and liquid coffee 40 flow through holes 281, 317, when valve 211 is in the closed state. Therefore, second layer 315 on membrane is supported by cover layer 293 in the example. And, first layer 311 and second layer 313 are in abutment when valve 211 is in the closed state.

First and second layers 311, 313 may be releasably held together by means of various systems. For example, first and second layers 311, 313 could separately comprise an adhesive layer and a release layer. By way of further example, first and second layers 311, 313 could separately comprise layers having an affinity of an ionic type in which opposite charges attract first and second layers 311, 313 together. Holding together of first and second layers 311, 313 whether by adhesive or ionic affinity provides a more complete closure against entry of air into valve 211 and cartridge 10, 10a.

In certain embodiments, first layer 311 is generally referred to as a no tack, ultra low tack, cling film, self wetting, removable adhesive, or cohesive substrate. In embodiments, the material for use in first layer 311 may also be characterized as a pressure-sensitive adhesive. First layer 311 should be of a material which does not permit gas flow therethrough and which is sufficiently impervious to liquid to prevent leakage. Copolymers of polyisobutylene and poly methyl methacrylate are illustrative materials for use as a first layer 311. First layer 311 may be about 0.25 mils to about 15 mils in thickness.

Second layer 313 may be a gas-impervious silicone or other dry release film layer. Membrane 315 with second layer 313 deposited thereon may be about 0.25 mils to about 15 mils in thickness. An example of a silicone material which may be used as a second layer 313 is polydimethysiloxane.

By way of example only, the affinity of first layer 311 for second layer 313 can be described in quantitative terms as a bond strength in the range of 0.25 grams/inch to 10 grams/inch when measured with a tensile tester in accordance with ASTM F-88. With the appropriate selection of materials and/or inherent surface energies of first and second layers 311, 313, the ability to form seals of controlled bond strength is established. The implementation of first layer 311 and second layer 313 provides a means for keeping membrane 315 in place against base layer 265 and achieving a gas-tight seal that enables valve 211 to function as a one-way pressure relief valve.

Persons of skill in the art will appreciate that either the first layer 311 or the second layer 313 could be an adhesive layer or a release layer or that either first layer 311 or second layer 313 could have an opposite charge and affinity of the ionic type.

As is illustrated in FIG. 14A, each of first and second layers 311, 313 and membrane 315 extends generally across the length (L) of valve 211, but is generally narrower than the width (W) of valve 211. Membrane 315 and first layer 311 are located between shoulders 297 in the example which prevents cover membrane 293 between shoulders 297 from being joined to base layer 265 by adhesive 295. This, in turn, permits cover membrane 293 to flex to open valve 211.

Bumpers 303, 305 may be secured to cover membrane 293 by adhesive 307 which may be the same as adhesive 107. Bumpers 303, 305 serve the same purpose as bumpers 103, 105 previously described. Operation of cartridge 10, 10a and valve 211 are described below.

Operation of the improved cartridges 10, 10a will now be described in connection with cartridge 10 of FIGS. 16-17 and 18-19A. It is to be understood that cartridge 10a of FIGS. 20-21 would function in the same manner.

Referring first to the example of FIG. 16, valve 11 or 211 is initially affixed over vent 57 and entirely in valve placement zone 63. Valve 11, 211 baffle 85, 285 and hole 81, 281 are located over vent 57 so that gas from within cartridge 10 can pass through vent 57 and into baffle 85, 285 and hole 81, 291. Baffle 85, 285 provides the user with flexibility in placement of valve 11 on lid 35 because vent 57 can be located anywhere within baffle 85, 285 or may be partially within baffle 85, 285 with other portions of vent 57 covered by adhesive layer 69, 269.

Valve 11 is initially in its closed state. Closure 91 is forced against base layer 65 by flexible cover layer 93 across hole 81 closing hole 81 and preventing gas flow therethrough preserving the freshness of ground coffee 51 or other particulate beverage material inside cartridge 10, 10a. Wetting agent 89, which may be provided between base filter layer 65 and closure 91, facilitates gas-tight abutment of closure 91 against base layer 65 and across hole 81.

Referring to FIG. 17, when pressure inside cartridge 10, 10a exceeds the target pressure required to open valve 11, cover membrane 93 flexes outwardly under the force of the target opening pressure. Flexure of cover membrane 93 spaces closure 91 slightly from base layer 65 first side 71 and hole 81. Flexure of cover membrane 93 loads cover membrane 93 much as a spring is loaded. Flexure of cover membrane 93 opens gas flow path 87 from hole 81 toward periphery 75 of base layer 65 as indicated by arrows 109 (FIG. 14), thereby allowing carbon dioxide gas to escape from cartridge 10, 10a and placing valve 11 in the open state.

When the differential pressure is decreased below the target pressure, cover membrane 93 of flexible seal 67 applies a force as it is unloaded and returns to its original position, or closed state, as illustrated in FIG. 16. The force causes closure 91 to return to abutment with base layer 65 first side 71 over hole 81 blocking movement of ambient air into cartridge 10, 10a through hole 81 and returning valve 11 to the closed state. The process of opening valve 11 is repeated when the differential pressure inside cartridge 10, 10a again exceeds the target opening pressure.

The valve 211 embodiment of FIG. 14A functions in the same manner as described in connection with valve 11 except that first and second layers 311, 313 contribute to closure of valve 211. When valve 211 is in its closed state, first layer 311 and second layer 313 are releasably held together to hold membrane 315 tightly against base layer 265 over holes 281 and 317. Flexible cover layer 293 also applies a force to membrane 315 which contributes to closure of valve 211 preventing entry of ambient air into cartridge 10, 10a. When pressure inside cartridge 10, 10a exceeds the target pressure required to open valve 211, cover membrane 293 flexes outwardly under the force of the target opening pressure. Flexure of cover membrane 293 releases and separates first and second layers 311, 313 slightly from the other and spaces membrane 291 slightly from base layer 265 first side 271 and holes 281, 317. The flexure and at least partial release of first and second layers 311, 313 opens gas flow path 287 from holes 281, 317 toward periphery 275 of base layer 265 as indicated by arrows 309 (FIG. 14), thereby allowing carbon dioxide gas to escape from cartridge 10, 10a and placing valve 211 in the open state. When pressure inside cartridge 10, 10a decreases below the target pressure, valve 211 again closes.

FIGS. 18-19A illustrate valve 11 and cartridge 10, 10a operation during the brewing process, for example using a Keurig brand brewer. Valve 211 would function in essentially the same manner. Valve 11, 211 is configured to prevent outflow of hot water 40, liquid coffee or other beverage filtrate from cartridge 10, 10a through valve 11, 211 when hot water 40 is injected into cartridge 10, 10a for brewing. Consequently, hot water 40 is able to mix with ground coffee 51 to brew the ground coffee 51. Liquid coffee filtrate from ground coffee 51 is directed out of cartridge 10, 10a only through brewer exit needle 28 and not through valve 11, 211. Cartridge 10, 10a is essentially liquid-tight under the liquid pressure conditions existent in the brewer. As a result, the liquid coffee or other beverage is directed to the user's cup (not shown) and malfunctions caused by liquid coffee or other filtrate leakage through valve 11 are avoided.

As represented schematically in FIGS. 18-19A, the Keurig Brewer (not shown) injects hot water 40 under pressure into K-Cup-type cartridge 10, 10a loaded in a holder (not shown) within the brewer. A volume of about 160 mL to about 220 mL of hot water is injected during brewing depending on the serving size selected. The entrance and exit needles 26, 28 may be inserted automatically by the brewer when the brewer handle is lowered with a K-Cup-type cartridge 10, 10a in the holder. Entrance needle 26 is inserted through lid 35 in puncture zone 59 and into head space 53 and exit needle 28 is inserted through bottom 41 of the K-Cup-type cartridge 10 and into lower space 54.

Hot water 40 is injected through entrance needle 26 and into cartridge 10, 10a where the hot water 40 fills cartridge 10, 10a and mixes with ground coffee 51. The injection of hot water under pressure can last as long as about 40 seconds. Liquid coffee or other beverage filtrate is drained through filter element 45 and from K-Cup-type cartridge 10, 10a through exit needle 28 whereupon the coffee ultimately collects in the user's cup.

The combination of vent 57, baffle 85, hole 81 and flexible seal 67 of valve 11, or vent 57, baffle 285, hole 281 and flexible seal 267 of valve 211 limit hot water 40 and/or liquid coffee flow out of cartridge 10, 10a and render cartridge 10, 10a essentially liquid-tight for a brewer application. More particularly, vent 57 and baffle 85, 285, hole 81, 281 and base layer 65, 265 and flexible seal 67, 267 defining gas flow path 87, 287 provide an inefficient and constrictive flow path for hot water 40 and/or liquid coffee. The gas flow path 87, 287 along which liquid would have to flow to exit valve 11, 211 could be characterized as “serpentine” because of the many turns which restrict liquid flow along the gas flow path 87, 287. The gas flow path 87, 287 is restrictive to liquid flow at least in part due to the fact that hot water 40 and liquid coffee are dense relative to carbon dioxide gas. Initially, vent 57 constricts movement of hot water 40 and/or liquid coffee through lid 35 because of the liquid density and small size of vent 57. Next, baffle 85, 285 acting as a buffer traps any initial flow of such hot water 40 and/or liquid coffee through vent 57. Baffle 85, 285 serves to reduce pressure of such hot water 40 and/or liquid coffee. Baffle 85, 285 provides for a momentary reduction in force of hot water 40 and/or liquid coffee while baffle 85, 285 is filled.

Without wishing to be bound by any particular theory, it is thought that baffle 85, 285 provides mitigation of a type of “water hammer” effect as pressurized hot water 40 and/or liquid coffee enters baffle 85, 285 reducing force that would otherwise open valve 11 allowing liquid to undesirably flow through valve 11 and to leak from cartridge 10, 10a. Once baffle 85, 285 fills with hot water 40 and/or liquid coffee, force will be transmitted to base layer 65, 265 where the narrow and small cross-sectional area of hole 81, 281 further restricts movement of hot water 40 and/or liquid coffee through base layer 65, 265 further limiting liquid pressure and contributing to liquid blockage.

Lastly, force applied by flexible seal 67 (i.e., closure 91, cover layer 93) and surface adhesion of closure 91 against base layer 65 first side 71 provided by wetting agent 89 or first and second layers 311, 313 of flexible seal 267 combine with the aforementioned elements to close hole 81, 281 and gas flow path 87, 287 to limit hot water 40 and/or liquid coffee from passing through valve 11, 211.

Accordingly, cartridges 10, 10a are unique in that they permit gas outflow yet limit liquid outflow. One way gas outflow can occur from valve 11 at pressure differentials which may be as little as about 0.2 psig between pressure inside and outside cartridge 10, 10a. And yet cartridges 10, 10a block passage of hot water 40 injected under pressure into cartridge 10, 10a. Cartridges 10, 10a can prevent hot water 40 and/or liquid coffee leakage even though as much as about 160 ml to about 220 mL of hot water 40 are injected into cartridge 10, 10a by brewer for as long as 40 seconds.

Improved cartridges 10, 10a of the type described herein permit the roaster to immediately load ground coffee 51 into filter element 45 and cartridge 10, 10a following roasting and grinding when coffee flavor is at its best. No degassing, with the associated degradation in coffee flavor, is required because improved cartridges 10, 10a permit carbon dioxide and other gas to be evacuated from cartridge 10, 10a. Accordingly, ground coffee 51 and other beverages can be provided to the consumer in an optimally fresh and flavorful condition to optimize the experience to the consumer.

By allowing one-way gas flow out of cartridge 10, 10a, the roaster avoids problems of cartridge 10, 10a swelling and distortion associated with conventional cartridges 1. Problems which are avoided can include: (1) possible difficulty in loading the cartridge into the brewer resulting from cartridge swelling and distortion; (2) possible negative consumer reaction to the appearance of a swollen cartridge at the point of sale or afterwards; and (3) possible damage to a carton (i.e., a secondary package) and to a case holding one or more cartons resulting from expansion of many cartridges; and (4) possible loss of cartridge integrity caused by a rupture or cartridge failure due to excessive cartridge internal pressures.

Improved cartridges 10, 10a also facilitate proper operation of the brewer in which the cartridge 10, 10a is loaded. Proper operation is ensured because cartridges 10, 10a of the type described herein function in the brewer in the same manner as a conventional undistorted K-Cup or cartridge 1 in that such cartridges 10, 10a have essentially no leakage when hot water 40 is injected into cartridge 10, 10a under pressure by the brewer. Consequently, the liquid coffee or beverage filtrate is directed toward the user's cup where it belongs and there is no mess to clean up or diluted beverage in the user's cup resulting from hot water 40, liquid coffee or other beverage filtrate leakage from cartridge 10, 10a.

While particular embodiments of the invention have been shown and described, other alternatives, variations, and modifications will occur to those skilled in the art. It is intended in the appended claims to cover all such alternatives, variations, and modifications that come within the true spirit and scope of the present invention.

What is claimed is:

1. In combination:
a single-serve beverage cartridge adapted to receive liquid injected by a brewer, the cartridge comprising:
a cup of a gas-and-liquid impermeable material having a shape and including a rim defining an opening;
a lid of a gas-and-liquid impermeable material sealed to the rim entirely around the opening and covering the opening,
a vent;
a puncture zone through which the brewer injects the liquid into the cartridge;
a valve placement zone; and
a granular beverage medium within the cup which generates gas creating pressure within the cartridge before the liquid injection; and
a one-way gas pressure relief valve which is essentially liquid-tight to the injected liquid, the valve comprising:
a base layer affixed over the vent and entirely within the valve placement zone, the base layer including a first side, a second side, at least one hole entirely through the base layer having a total cross-sectional area of less than about 0.000314 in² and adhesive on the second side affixing the base layer to the cartridge over the vent, the adhesive having an inner edge surrounding the at least one hole to define, with the base layer second side, a liquid flow-restricting baffle positioned over the vent and in gas-flow communication with the at least one hole; and
a flexible seal including a first region joined to the base layer first side spaced at least partially from the at least one hole and a second region unjoined to the base layer first side covering the at least one hole to define, with the base layer first side, a gas flow path from the at least one hole to a periphery of the flexible seal, the flexible seal flexing responsive to the gas pressure to at least partially open the gas flow path and permit gas outflow from the cartridge,
whereby the valve (1) relieves the gas pressure before the liquid injection thereby maintaining the cup shape and the seal while permitting the beverage medium to be packaged in the cartridge without substantial degassing and (2) limits flow of liquid out of the cartridge.

2. The combination of claim 1 wherein the lid includes the puncture zone, the valve placement zone and the vent, and the valve is attached to the lid over the vent.

3. The combination of claim 2 wherein the cartridge is a K-Cup.

4. The combination of claim 3 wherein the beverage medium is coffee.

5. The combination of claim 2 wherein the at least one hole in the base layer includes plural holes.

6. The combination of claim 2 wherein the vent has a cross-sectional area of less than about 0.00019 in².

7. The combination of claim 2 wherein the inner edge of the adhesive defining the baffle is spaced entirely from the at least one hole in the base layer.

8. The combination of claim 7 wherein the baffle reduces liquid force.

9. The combination of claim 8 wherein the flexible seal first region is joined to the base layer first side by an adhesive.

10. The combination of claim 2 further including a wetting agent between the base layer and the flexible seal.

11. The combination of claim 2 wherein the flexible seal comprises:
a first layer atop the base layer first side around the base layer hole;
a flexible cover layer over the first layer and the base layer hole; and
a second layer supported by the flexible cover layer facing the first layer and covering the base layer hole, the first and second layers being releasably held together to form a seal blocking passage of gas and liquid,
whereby flexing of the flexible seal separates the first and second layers sufficiently to allow gas to flow along the gas flow path.

12. The combination of claim 2 wherein the flexible seal flexes to allow gas to flow along the gas flow path when cartridge internal gas pressure exceeds ambient air pressure by about 0.2 psig.

13. The combination of claim 2 wherein the valve has a footprint area of less than about 0.25 in².

14. The cartridge of claim 13 wherein the lid defines a circle with a center, the puncture zone comprises a circle concentric with the center and the valve placement zone is concentric with both the center and the puncture zone.

15. The combination of claim 14 wherein the lid has a radius of less than about 1 inch and the puncture zone has a radius of about 0.5 inch.

16. A lid component for closure of a single-serve beverage cartridge, the lid component comprising:
a lid including a puncture zone through which a brewer can inject liquid into the cartridge, a valve placement zone and a vent in the valve placement zone; and
a one-way gas pressure relief valve which is essentially liquid-tight to the injected liquid affixed to the lid in the valve placement zone, the valve comprising:
a base layer affixed over the vent and entirely within the valve placement zone, the base layer including a first side, a second side, at least one hole entirely through the base layer having a total cross-sectional area of less than about 0.000314 in² and adhesive on the second side affixing the base layer to the lid, the adhesive having an inner edge surrounding the at least one hole to define, with the base layer second side, a liquid flow-restricting baffle positioned over the vent and in gas-flow communication with the at least one hole; and
a flexible seal including a first region joined to the base layer first side spaced at least partially from the at least one hole and a second region unjoined to the base layer first side covering the at least one hole to define, with the base layer first side, a gas flow path from the at least one hole to a periphery of the flexible seal, the flexible seal flexing responsive to gas pressure within the cartridge to at least partially open the gas flow path and permit gas outflow from the cartridge.

17. A plurality of the lid components of claim 16 on a release liner.

18. The lid component of claim 16 wherein the lid has an outer side and the valve is affixed to the outer side.

19. The lid component of claim 16 wherein the at least one hole in the base layer includes plural holes.

20. The lid component of claim 16 wherein the vent has a cross-sectional area of less than about 0.00019 in².

21. The lid component of claim 16 wherein the inner edge of the adhesive defining the baffle is spaced entirely from the at least one hole in the base layer.

22. The lid component of claim 21 wherein the baffle reduces liquid force.

23. The lid component of claim 16 further including a wetting agent between the base layer and the flexible seal.

24. The lid component of claim 16 wherein the flexible seal comprises:
a first layer atop the base layer first side around the base layer hole;
a flexible cover over the first layer and the base layer hole; and
a second layer supported by the flexible cover facing the first layer and covering the base layer hole, the first and second layers being releasably held together to form a seal blocking passage of gas and liquid,
whereby flexing of the flexible seal separates the first and second layers sufficiently to allow gas to flow along the gas flow path.

25. The lid component of claim 16 wherein the flexible seal flexes to allow gas to flow along the gas flow path when cartridge internal gas pressure exceeds ambient air pressure by about 0.2 psig.

26. The lid component of claim 16 wherein the valve has a footprint area of less than about 0.25 in².

27. The lid component of claim 26 wherein the lid defines a circle with a center, the puncture zone comprises a circle concentric with the center and the valve placement zone is concentric with both the center and the puncture zone.

28. The lid component of claim 27 wherein the lid has a radius of less than about 1 inch and the puncture zone has a radius of about 0.5 inch.
